(19) United States
(12) Patent Application Publication
(10) Pub. No.: US 2006/0163856 A1
(43) Pub. Date: Jul. 27, 2006

(54) Gas bag module for a vehicle occupant restraint device

(75) Inventor: Michael Lehmann, Aschaffenburg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/335,345

(22) Filed: Jan. 19, 2006

(30) Foreign Application Priority Data
Jan. 21, 2005 (DE) 20 2005 001 000.6

(51) Int. Cl. B60R 21/239; B60R 21/235

(52) U.S. Cl. 280/743.1; 280/742

(57) ABSTRACT

A gas bag module for a vehicle occupant restraint device has a gas bag and a discharge control arrangement to expose and/or change a discharge opening through which gas can escape from the gas bag. The discharge control arrangement has at least one element made from a memory metal.

### TECHNICAL FIELD

The invention relates to a gas bag module for a vehicle occupant restraint device.

### BACKGROUND OF THE INVENTION

A gas bag module having a gas bag and a discharge control arrangement to open a discharge opening through which gas can escape from the gas bag is known for example from WO-A-2004/045919. The discharge region can be opened in the gas bag wall when a reduction in the gas bag internal pressure is required. A pyrotechnic charge in the form of a fuse is arranged directly on the discharge region such that the discharge region burns through or is torn open mechanically after the fuse has been ignited.

In the gas bag module shown in WO-A-03/097407 a pyrotechnic pin is provided in order to expose a tube-shaped discharge region of the gas bag.

In EP-A-1 279 574 a gas bag module is shown in which a slider is moved to open discharge openings in a holding piece, such that bores formed therein come in alignment with the discharge openings. The hot gas which is flowing into the gas bag melts the region of the gas bag which is situated between the bores of the slider and the discharge openings in the holding piece such that a portion of the gas emerges from the gas bag during filling.

From U.S. Pat. No. 6,547,274 B a gas bag module is known in which the opening cross-section of a discharge opening in a carrier plate can be opened by piezoelectrically controlled flaps. The current supply of the piezoelectric elements is controlled, for example, depending on the posture or the physique of the vehicle occupant or on the speed of the vehicle.

The invention provides a gas bag module which makes it possible to control the discharge behaviour in a manner which is not dangerous for the vehicle occupant, without enlarging the structural space.

### BRIEF SUMMARY OF THE INVENTION

According to the invention, a gas bag module for a vehicle occupant restraint device has a gas bag and a discharge control arrangement to open and/or change a discharge opening through which gas can escape from the gas bag. The discharge control arrangement has at least one element made from a memory metal. Special alloys having shape memory characteristics are designated as memory metals, which include, amongst others, nickel-titanium, copper-zinc-aluminium, gold-cadmium or iron-manganese-silicon alloys. An element formed from such an alloy can be bent into any desired shape at low temperatures, but returns again into its previously impressed initial shape on heating above a so-called transformation temperature. Relatively great forces are produced thereby, i.e. upon the return deformation, an appreciable resistance can also be overcome. The heating which is necessary for the return deformation can also be brought about by an electric current flowing through the element. The invention makes use of the memory effect in order to systematically influence the discharge behaviour of a gas bag module. More precisely, the element made from memory metal according to the invention is used to control the effective cross-section of the discharge opening, i.e. the element provides for the production of a discharge opening and/or provides for a change to the discharge cross-section. Large and costly opening mechanisms can be dispensed with due to the use of such an element. The discharge control arrangement according to the invention in addition has the advantage that neither explosive substances or the like nor a melting of gas bag fabric are necessary for opening a discharge opening, i.e. a separation of particles is ruled out.

Basically, the discharge opening, which is controlled by means of the discharge control arrangement according to the invention, can be provided in a fixed component of the gas bag module or in the gas bag.

In the latter case, provision is made in a preferred embodiment that the gas bag comprises at least one wire made from the memory metal.

Preferably, the wire is integrated into the gas bag wall, in particular woven into the fabric of the gas bag wall. Upon heating of the wire, a deformation of the fabric of the gas bag wall then takes place, whereby a discharge region can be produced, enlarged or reduced in the gas bag wall.

Alternatively, the wire may also be part of a covering which is arranged over a discharge opening formed in the gas bag wall.

A further preferred embodiment makes provision that the element made from the memory metal is arranged on a tube-shaped discharge region of the gas bag.

A constriction of the tube-shaped discharge region to inhibit the emergence of gas or an expansion of a constriction to assist the emergence of gas can be achieved in that the element made from the memory metal is designed such that it is transformed, by heating, either from a less markedly curved shape into a more markedly curved shape, or, vice versa, from a more markedly curved shape into a less markedly curved shape.

For the systematic deformation of a discharge region, the element made from the memory metal can also be designed such that it is transformed, by heating, from an elongated shape into a bent shape, or, vice versa, from a bent shape into an elongated shape.

When the element made from the memory metal is arranged on a swivellable flap, a hinge mechanism can be produced in this way to control the flap.

It is basically also possible to form a discharge region of the gas bag substantially entirely from a structure made from the memory metal.

### BRIEF DESCRIPTION OF THE DRAWINGS

FIGS. 1a, 1b diagrammatically show a first embodiment of the invention;

FIGS. 2a, 2b diagrammatically show a second embodiment of the invention;

FIGS. 3a, 3b diagrammatically show a third embodiment of the invention; and

FIGS. 4a, 4b diagrammatically show a fourth embodiment of the invention.

### DETAILED DESCRIPTION OF THE PREFERRED EMBODIMENTS

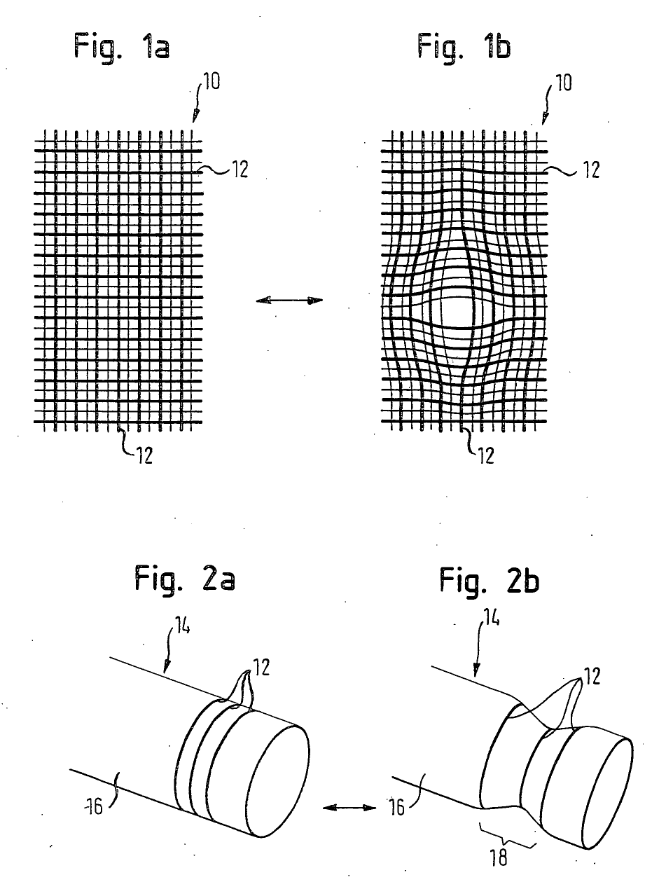

FIG. 1 a illustrates a spread-out piece of fabric 10 of a gas bag for a gas bag module of a vehicle occupant restraint device according to a first embodiment of the invention. Metal wires 12 made from a memory metal, which have the shape memory characteristics described above, are woven into the fabric piece 10. In the state below the transformation temperature specific to the material, shown in FIG. 1, the fabric piece 10 is slightly gas-permeable or gas-tight and, owing to the deformability of the metal wires 12, it is only slightly more rigid than a comparable fabric without metal wires 12 woven in.

After heating the metal wires 12 above the transformation temperature, which can be brought about, for example, by a systematic flow of current through the metal wires 12, the metal wires 12 assume their previously impressed initial shape, shown in FIG. 1b. This deformation of the metal wires 12 in the fabric piece 10 leads to a region in the fabric piece 10 being created or enlarged, through which (more) gas can flow off.

The fabric piece 10 may either be woven directly into the gas bag wall, or may be a covering which is arranged over a discharge opening which is formed in the gas bag wall. It is basically also possible to produce the entire discharge region from the memory metal wire 12.

In the second embodiment of the invention, shown in FIGS. 2a and 2b, a tube-shaped discharge region 14 is provided in the gas bag. In the tube 14, in accordance with FIG. 2a, several wires 12 made from a memory metal are sewn or woven, encircling radially, into the casing 16 of the tube 14, with the curvature of the metal wires 12 matching the adjoining regions of the tube 14.

After the metal wires 12 are heated, they assume a shape which is more markedly curved than the adjoining regions of the tube 14, as shown in FIG. 2b. Thereby, a constricted region 18 is formed, which delimits the quantity of gas being discharged per unit of time with respect to the state shown in FIG. 2a.

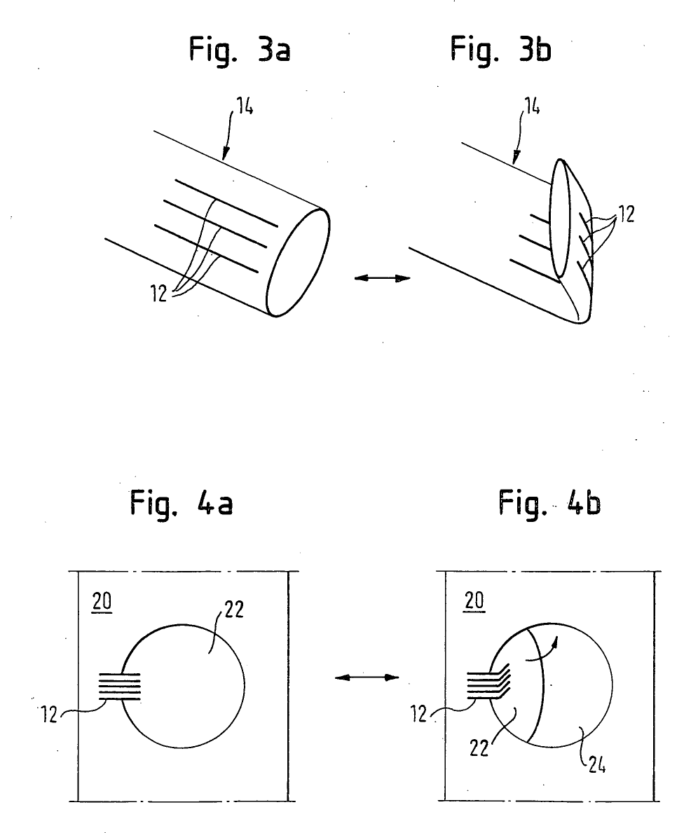

A third embodiment of the invention is shown in FIGS. 3a and 3b, in which likewise a tube-shaped discharge region 14 is provided. Here, however, the wires 12 which are made from the memory metal are sewn in or woven in in axial direction (see FIG. 3a) and assume a bent shape after heating (see FIG. 3b). The bending of the wires 12 brings about the formation of a fold in the tube 14, which inhibits the exit of gas.

The principle of forming a bend is also utilized in the embodiment shown in FIGS. 4a and 4b. The metal wires 12, which are elongated in the non-heated state, extend from a marginal region 20 to a swivellably arranged flap 22, which closes a discharge opening 24. After heating, the wires 12 bend in the transition region and swivel the flap 22 into an open position in which the discharge opening 24 is opened. The wires 12 made from the memory metal therefore serve as a hinge which automatically carries out a swivelling of the flap 22 through the supply of heat. The flap 22 can be provided in a suitable region of the gas bag; it is, however, also possible to construct the flap 22 from solid materal and to use it to open a discharge opening 24 which is formed in a fixed component of the gas bag module.

In all the embodiments, a “reverse” construction is also conceivable, i.e. the state shown in FIGS. 1a, 2a, 3a or 4a is achieved after heating from the state shown in FIGS. 1b, 2b, 3b or 4b, through corresponding deformation of the metal wires 12.

A utilization of the so-called two-way effect, in which the change in shape of an element made from memory metal, brought about by heating, forms back again through cooling, additionally permits further possibilities of control for the discharge control arrangement according to the invention. Thus, for example, the associated discharge opening can be (partially) opened or closed several times by a chronologically controlled flow of current through the wires 12 which are made from the memory metal.

1. A gas bag module for a vehicle occupant restraint device, the gas bag module having a gas bag and a discharge control arrangement to open and/or change a discharge opening through which gas can escape from the gas bag, wherein the discharge control arrangement including at least one element made from a memory metal.

2. The gas bag module according to claim 1, wherein the discharge opening is provided in the gas bag.

3. The gas bag module according to claim 2, wherein the gas bag comprises at least one wire made from the memory metal.

4. The gas bag module according to claim 3, wherein the wire is integrated into the gas bag wall.

5. The gas bag module according to claim 3, wherein the wire is part of a covering which is arranged over a discharge opening formed in the gas bag wall.

6. The gas bag module according to claim 1, wherein the element made from the memory metal is arranged on a tube-shaped discharge region of the gas bag.

7. The gas bag module according to claim 1, wherein the element made from the memory metal is designed such that it is transformed, by heating, either from a less markedly curved shape into a more markedly curved shape, or, vice versa, from a more markedly curved shape into a less markedly curved shape.

8. The gas bag module according to claim 1, wherein the element made from the memory metal is designed such that it is transformed, by heating, either from an elongated shape into a bent shape, or, vice versa, from a bent shape into an elongated shape.

9. The gas bag module according to claim 8, wherein the element made from memory metal is arranged on a swivellable flap.

10. The gas bag module according to claim 1, wherein a discharge region of the gas bag is formed substantially entirely from a structure made from the memory metal.

11. The gas bag module according to claim 1, wherein the discharge opening is provided in a fixed component of the gas bag module.
